(19) United States
(12) Patent Application Publication
(10) Pub. No.: US 2011/0055935 A1
(43) Pub. Date: Mar. 3, 2011

(54) SYSTEM FOR GROUP ACCESS TO SHARED MEDIA, RESOURCES, AND SERVICES

(75) Inventors: JEYHAN KARAOGUZ, IRVINE, CA (US); JAMES D. BENNETT, HROZNETIN (CZ)

(73) Assignee: BROADCOM CORPORATION, IRVINE, CA (US)

(21) Appl. No.: 12/549,586

(22) Filed: Aug. 28, 2009

(51) Int. Cl. G06F 15/16; G06F 21/00

(52) U.S. Cl. 726/29; 709/217; 709/204; 709/229; 709/231

(57) ABSTRACT

A system and method for establishing a group of wireless devices for sharing software and hardware resources as well as media stored thereupon associates each group member device of the group of wireless devices, communicates with at least some of the group member devices of the group of wireless devices to identify shared media and upon receiving a request transmitted by a group member device of the group of wireless devices, supports access to shared media. The shared media may be stored on a different group member device, upon a managing portal device, or a media server. Upon a successful validation, the group member device that made the request is notified to facilitate the access to the shared media. The notification includes access information.

### BACKGROUND

1. Technical Field

The present invention relates to wired and wireless communications and, more particularly, to circuitry for accessing shared media.

2. Related Art

In today's world of rapidly changing devices that instantly add features that become a significant part of everyday life, the Internet has served as a backbone for coupling networks of all types include cellular and wireless local area networks as well as wired networks. As different devices are developed to operate using these networks, popular features are often limited to the particular devices. Thus, devices are often application specific incompatible application related data formats and associated interfaces through they are operable to communicate over the various wireless and wired networks.

Many communication systems are known to support wireless and wire lined communications between wireless and/or wire lined communication devices, nonetheless, to support global communications. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards, including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of a plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via a public switch telephone network (PSTN), via the Internet, and/or via some other wide area network.

Each wireless communication device includes a built-in radio transceiver (i.e., receiver and transmitter) or is coupled to an associated radio transceiver (e.g., a station for in-home and/or in-building wireless communication networks, RF modem, etc.). The various circuit blocks of a radio transceiver jointly operate to support communications and associated functionality according to the type of communication system(s) it supports.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a functional block diagram illustrating a communication system that includes circuit devices and network elements and operation for accessing shared media according to one embodiment of the invention.

FIG. 2 is a functional block diagram of a network that illustrates operation for accessing shared media according to a first embodiment of the invention in which shared media does not flow through the group manager portal.

FIG. 3 is a functional block diagram that illustrates operation for accessing shared media according to a second embodiment of the invention in which shared media flows through the group manager portal.

FIG. 4 is a functional block diagram that illustrates operation for accessing shared media according to a second embodiment of the invention in which shared media stored on one group member device is accessed by another group member device.

FIGS. 5 and 6 are functional block diagrams that illustrate operations for accessing shared media from a plurality of media sources in which different group members are primary group members for accessing the shared media from corresponding media sources according to one embodiment of the invention.

FIG. 7 is a functional block diagram of one embodiment of a group manager portal.

FIG. 8 is a functional block diagram of a group member device according to one embodiment of the invention.

FIG. 9 illustrates a method for creating and managing group access to shared media that includes associating a plurality of group member devices to a group and storing access permissions for accessing shared media for at least one the plurality of group member devices.

FIG. 10 is a flowchart that illustrates a method for delivering media content to one group member device through another according to one embodiment of the invention.

FIG. 11 illustrates a method by a handheld first group member device operable to access shared media based on a group association that includes a plurality of group member devices according to one embodiment of the invention.

FIG. 12 illustrates a method by a handheld first group member device operable to deliver shared media based on a group association that includes a plurality of group member devices according to one embodiment of the invention.

FIG. 13 illustrates a method by a handheld first group member device operable to deliver shared media based on a group association that includes a plurality of group member devices according to an alternate embodiment of the invention.

FIG. 14 illustrates a method by a group member device for accessing shared media based on a group association that includes a plurality of group member devices according to an embodiment of the invention.

FIG. 15 is a signal sequence diagram that illustrates operation for resource sharing according to one embodiment of the invention.

### DETAILED DESCRIPTION OF THE DRAWINGS

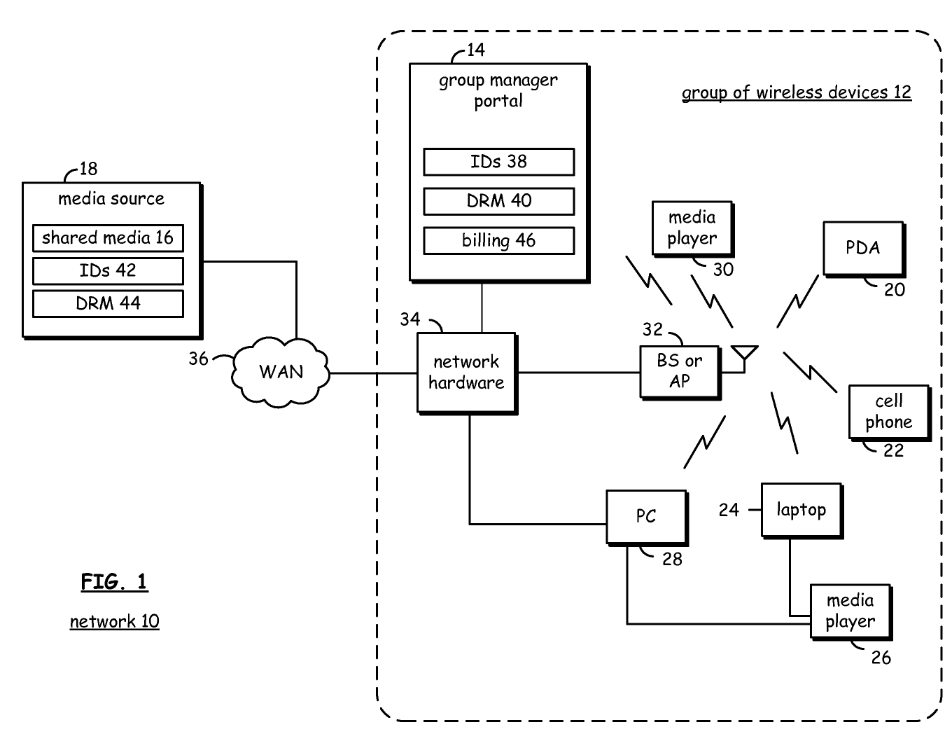

FIG. 1 is a functional block diagram illustrating a communication system that includes circuit devices and network elements and operation for accessing shared media according to one embodiment of the invention. A network 10 includes a group of wireless devices 12 that are each operable to communicate with a group manager portal 14 to access shared media 16 that is distributed by a media source 18, to access network services, and to facilitate resource sharing. Group manager portal 14 can be a server or other device located remotely (from the user) at a service provider location or, as shown, a device within the group of wireless devices 12. Group manager portal 14 may be a primary communication device communicatively coupled to a network through a wired network or wirelessly coupled. For example, the group manager portal 14 may comprise a dedicated appliance that operates as an account manager for the group of wireless (and wired) devices or, alternately, a designated device that is operable to support the required functionality disclosed herein. For example, the designated device may be a cell phone having such capabilities.

The group member devices of the group of wireless devices 12 includes a plurality of group member devices 20-30 that are associated as a group and have access rights to share at least one of shared media 16 (including streaming media), device hardware, device software, account and access information, data stored within the device, shared services and even access right to shared services. The shared media may be discrete files of media (e.g., video or audio content, electronic books, etc.) or streaming media received by a plurality of group member devices. All references to shared media include both discrete files of media and streaming media unless specifically limited in one example. All references to shared resources include all device content, logic, hardware and software that can be shared. The group member devices of the group of wireless devices 12 are operably coupled to communicate with group manager portal 14 and media source 18 by way of one or more of an access point/base station 32, a network hardware 34 and a wide area network (WAN) 36.

Access point/base station 32 supports communications with wireless devices using various wireless local area network and/or cellular protocols. For example, common access points utilize IEEE 802.11 based protocols while common base stations utilize variations of well-known cellular communication protocols. Reference to access point/base station 32 should be understood to refer to either type of device that may be used by a remote wireless communication device to gain access to a corresponding network. Network hardware 34 typically comprises a local area network router and a firewall to reduce unwanted intrusions by others of a local area network or, for a cellular network, cellular network hardware that can include base station controllers, switching centers, databases, etc., to support call routing and processing. Generally, such network hardware acts as a bridge to a communication infrastructure to support digital subscriber line (DSL) or any other network interface that provides or supports broadband service.

The group member devices of the group of wireless devices 12, in the illustrated embodiment of FIG. 1 includes a personal digital assistant (PDA) 20, a cell phone 22, a laptop computer 24, a media player 26, a personal computer 28 and a media player 30. Collectively, these devices are referenced as group member devices 20-30. The group member devices 20-30 are operable to access shared media 16, services and resources by being associated as a group of wireless devices 12 having access rights to the shared media 16. As will be described in more in relation to the figures that follow, each of the group member devices 20-30 is operable not only to share media, but also to access or share hardware resources (e.g., radio resources or memory) of other of the group member devices 20-30. This enables the group member device to establish communications with remote devices such as group manager portal 14 or media source 18 or a network service provider for a variety purposes. The variety of purposes for one device to share resources of another device include using the hardware resource to access shared media 16, for example, when it cannot otherwise establish the communications to access the shared media 16 within media source 18 or to save usage or operational costs.

As a part of establishing a group association of group member devices 20-30, group manager portal 14 is operable to store a list of authorized identities 38 for determining access to shared media 16 based on stored digital rights management specifications (DRM) 40. Generally, each of the group member device identities for group member devices 20-30 are entered into memory of group manager portal 14 or are received by group manager portal 14 from at least one group member of the group of wireless devices 12. The identities are stored in a way to create an association or group for the group member devices 20-30. The associations may be permanent (until changed) or for a limited or specified duration.

Digital rights management (DRM) refers to access control technologies that limit access and use of content. Generally, DRM limits the playback of protected content to prevent copying and/or unpaid use of such content. Additionally, hardware often limits access to content because content is formatted in a manner in which only specified types of devices can access the content. As such, a user typically purchases multiple hand held devices to access various types of content and or services. Generally, DRM and/or hardware limitations preclude access and limit enjoyment of content and/or services that are purchased by a user. The embodiments of the invention, among other aspects, address authorized access to shared media that would otherwise by limited by digital rights management or by hardware limitations.

In one embodiment, for example, the group member devices 20-30 may be associated with a cell phone account of cell phone 22. Thus, a cell phone service provider, as a part of managing or establishing a cell phone account for cell phone 22, may enter the device IDs to create the group. Here, a user of cell phone 22 may be defined as being a primary group member device and, as such, may be given access to create the group or association of group member devices 20-30. In this example, a user of cell phone 22 would access the cell phone account and then enter the device identities for each of the group member devices 20-30 to create the group.

As a primary group member device, cell phone 22 is further operable to modify account information, features and usage parameters for the group member devices 20-30 of the group of wireless devices 12. Accordingly, when the particular account is accessed by cell phone 22, specified data and control parameters are produced or displayed to cell phone 22. Changes to the specified data and control parameters made by cell phone 22 are then accepted and stored by group manager portal 14 according to access rights given to cell phone 22.

To illustrate, the user, through cell phone 22, could select types of media that may be shared and a total amount of access or usage of the shared media. This total amount of access could be specified as a group total, individual group member device totals (could be different for the different devices) or even sub-group totals. For sub-groups, sub-group members of the sub-group could have equal allocations that are different from other sub-groups. Corresponding identities 38 of the devices, sub-groups and/or groups are stored by group manager portal in memory in identities 38 in relation to access permissions.

In one embodiment of the invention, group manager portal 14 communicates with each of the group member devices 20-30 as a part of creating the association to validate subsequent access requests by any one of group member devices 20-30 to access shared media 16. For example, group manager portal 14 may communicate with each group member device to obtain additional identity or access information to support group access operations for shared media such as accessing shared media 16 in discrete files or as streaming media.

The shared media 16 includes shared media that is stored on media source 18 (as shown) or shared media that has been previously downloaded (not shown here) either to group manager portal 14 or to one or more of the group member devices 20-30 or media that is delivered as streaming media. Thus, the group manager portal 14 is operable to associate each of the group member devices 20-30 to the group of wireless devices 12 to establish group membership for the group of wireless devices 12. For the case in which the shared media is stored upon the group devices, the group manager portal 14 communicates with at least some of the group member devices 20-30 to identify shared media stored thereupon.

The group manager portal 14 is further operable to, upon receiving a request transmitted by one of the group member devices 20-30, validate access to shared media 16 that is stored on a differing group member device, to support access the shared media 16 from a media source, and to notify at least the one group member device of the group member devices 20-30 making the request to facilitate the access. Notifying at least one group member comprises at least one of transmitting access information including location information, access codes, encryption keys, required identities, etc. Notifying can also occur by transmitting shared media content that has been decrypted or partially decrypted.

The group manager portal 14 stores computer instructions that define digital rights management requirements 40 that include group access rights for associated group member devices such as group member devices 20-30 and allows access to the shared media by the group member devices in a manner that corresponds to the digital rights management requirements 40. Accordingly, when one of the group member devices 20-30 requests access to shared media 16, group manager portal 14 is operable to validate the request. The access rights may, however, be specific to individual group members or sub-groups of group member devices wherein different group members of group member devices 20-30 have different access rights in relation to other group members of group member devices 20-30.

In one embodiment, group manager portal 14 monitors a number of times the shared media 16 is accessed by one or of the group member devices 20-30. It then denies access after the shared media has been accessed a specified number of times either collectively by the group of wireless devices 12 or by the group member device of the group member devices 20-30 or by a sub-group of the group member devices 20-30. Such access limitations may be based on digital rights management requirements 40 or a combination of such requirements 40 and usage agreements for the group member devices 20-30 and/or group of wireless devices 12.

Group manager portal 14 is further operable to maintain a billing record 46 for at least one of shared services which can further includes shared media (stored media and streaming media, communication services, data services, etc.) for subsequent billing for the service sharing by the group member devices 20-30 according to usage terms. In one particular embodiment, group manager portal 14 maintains a billing record for particular shared media transfers that is associated with a cell phone account, for example, for cell phone 22 of the group member devices 20-30. Cell phone 22, in this example, is a primary group member device that has particular account access rights to modify data and control parameters associated with the group of wireless devices for one or more of the group member devices 20-30. In the embodiment shown, group manager portal 14 comprises a host computer and portal software that resides on the host computer.

Group manager portal 14, in one embodiment, comprises a PC host that operates to host portal software and/or act as a portal device. Such a PC host may be communicationally disposed within a private or home network or remotely to communicate with the group of wireless devices 12 via WAN 36. Whether a cell phone, such as cell phone 22 or a PC host device operates to host portal software and/or act as a portal device, media sharing, service sharing, and resource sharing typically include communications over one or more networks including data packet networks and telephone networks and infrastructure. Accordingly, in one embodiment, the PC host device with the portal software, or more generally, a group manager portal is associated with a telephone network infrastructure.

In one specific embodiment, a PC host device that hosts the portal software is operable to receive and respond to first instruction signals to request access or sharing of media, services or resources and to second instruction signals for grouping related operations. Thus, for example, cell phone 22 may transmit the second instruction signals to a PC host (e.g., group manager portal 14) to form an association between at least two of group of wireless devices 12. Similarly, the first instruction signal may be transmitted by any one of the group of wireless devices 12.

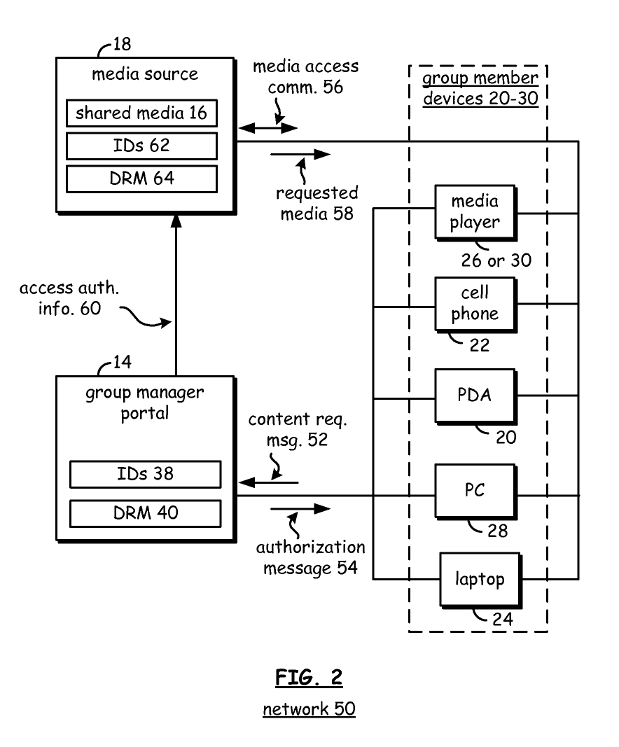

FIG. 2 is a functional block diagram of a network that illustrates operation for accessing shared media according to a first embodiment of the invention in which shared media does not flow through the group manager portal. The network 50 of FIG. 2 is similar to network 10 of FIG. 1. Discussion of commonly numbered elements will not be repeated, but it should be understood that the prior discussions of such elements apply here as well. Network 50 operates as described in relation to network 10 to establish access rights for group member devices 20-30. Once access rights are established, in relation to groups, sub-groups, or individual group member devices, group manager portal 14 is operable to receive a content request message 52 requesting access to shared media 16 and to validate the access request. Content request message 52 can be received from any of group member devices 20-30. Content request message 52 can be solely for the device that transmitted content request message 52 or it could be for another device that also is a group member as will be described in greater detail below.

Once group manager portal 14 validates content request message 52 by determining that the group member device or devices seeking access to shared media 16 are authorized, group manager portal 14 transmits authorization message 54 to the group member device of group member devices 20-30 that transmitted content request message 52. In the described embodiment of FIG. 2, once the group member device that transmitted content request message 52 receives authorization message 54, that device engages in media access communications 56 with media source 18 to download or access shared media 16 as requested media 58.

Media access communications 56 refer to communications between a media source or device with stored media and a device to establish that the device seeking access to the stored media is an authorized device. Such media access communications 56 can comprise one or more messages. Such messages may include, for example, a group identity, a sub-group identity, a group member identity, a transaction identity, an identity of the media for which access is being requested, etc.

Group manager portal 14 is further operable to transmit access authorization information 60 to media source 18 either in response to receiving a content request message from one of group member devices 20-30 to access shared media 16 or in advance to support shared access to shared media 16 by group member devices 20-30. For example, group manager portal 14 may send at least one of a group identity, a sub-group identity or a list of group member device identities having an association for accessing shared media 16 to enable any one of group member devices 20-30 to request shared media 16. Accordingly, media source 18 stores authorized identities 62.

The access authorization information 60 may also include, in the same or subsequent transmissions or messages, information to allow access that corresponds to a specific content request message 52 transmitted by one of group member devices 20-30. Accordingly, media source 18 transmits shared media 16 to respond to content request message 52 according to DRM specifications 64. One aspect of DRM specifications 40 and/or 64 in the described embodiment of the invention is that group access to specified media content is validated based on group associations. The access authorization information 60 and the media access communications 56 facilitate a media source's process, such as media source 18, to deliver media to authorized devices that belong to an associated group.

Another aspect of DRM specifications 40 and 64 in the described embodiment is that the group member devices 20-30 may be different types of devices having different types of hardware resources and associated capabilities wherein the group members of an associated group are allowed to use each other's resources to gain access to shared media (including streaming media) and/or other shared services. For example, PDA 20 may access the memory of media player 30 to download shared media stored by media player 30. Alternatively, PDA 20 may utilize hardware resources of media player 30 to download shared media 16 from media source 18. A media player 30 may establish a communication link with 52 to access network hardware 34 and media source 18 or, alternately, may utilize network resources of personal computer 28 or, more generally, to communicate with a remote device to access a service. The service may be any type of network based service. Thus, references to services and include but are not limited to communicating with media source 18 through network hardware 34 to retrieved stored media or streaming media.

In the example shown, media source 18 evaluates at least one identity (could a group identity, a sub-group identity or a device identity) that is identified in the media access communications 56 in relation to authorized identities stored in authorized identities 62. Media source 18 is then able to determine that the group member device is one of the group member devices 20-30 that is authorized to access the requested media. Accordingly, media source 18 transmits requested media 58 or allows the group member device to download requested media 58.

Many different approaches may be employed for allowing media source 18 to validate a request to shared media 16 while engaged in media access communications 56. In one embodiment, for example, group manager portal 14 transmits a transaction ID within access authorization information 60 to media source 18 and within authorization message 54 to the group member device seeking access to shared media 16. Accordingly, the group member device transmits the transaction ID within media access communications 56.

In another embodiment, access authorization information 60 includes a listing of identities (group, device, and/or sub-group). Accordingly, the group member device also produces the same identity when requesting access to shared media 16 or other services. The variations of the content of access authorization information 60, authorization message 54 and media access communications 56 may readily be modified according to design or system requirements.

One aspect, however, of the embodiment of the invention of FIG. 2 is that group manager portal 14 communicates with both media source 18 and at least one of group member devices 20-30 as a part of a process in which the group member devices 20-30 are given access to shared media 16. The group member device of group member devices 20-30, upon receiving authorization from group manager portal 14 in authorization message 54 then communicates with media source 18 to download requested media 58 from media source 18. Such communications may also occur with other service providers when the access or sharing request is for another service. Thus, a content request message may be in form a sharing request message for sharing a service that is different from sharing media. The example here, however, is directed to access for shared media.

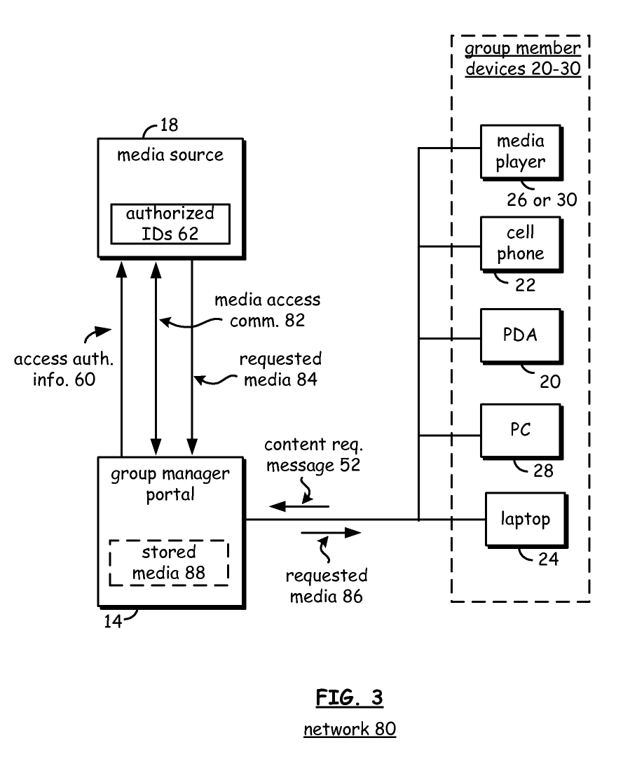

In the operations illustrated here in FIG. 2, group manager portal 14 validates or authorizes access to media content stored on another device (namely, media source 18). In other embodiments, shared media 16 may be stored on a group member device of group member devices 20-30 wherein group manager portal 14 authorizes access to the shared media 16 stored on the group member device. Additionally, as will be shown in relation to FIG. 3 below, the shared media 16 may also be stored within or flow through group manager portal 14.

FIG. 3 is a functional block diagram that illustrates operation for accessing shared media according to a second embodiment of the invention in which shared media flows through the group manager portal. As described in relation to FIG. 2, the example of FIG. 3 may be easily modified to specifically support sharing for other types of network based services. In FIG. 3, a network 80 includes group manager portal 14, media source 18 and group member devices 20-30 as described before. Here, however, group manager portal 14 engages in media access communications 82 with media source 18 and receives, in response, requested media 84 from media source 18. Thereafter, group manager portal 14 transmits the requested media or allows the requesting group member device to download requested media 86. In one embodiment, the media access communication 82 and download of requested media 84 occurs in response to group manager portal 14 receiving and validating content requested message content request message 52. In another embodiment, the media access communication 82 and requested media 84 can occur prior to receiving content request message 52. Here, requested media is stored within group manager portal 14 as stored media 88. Accordingly, after receiving content request message 52, group manager portal 14 transmits requested media 86 (or allows requested media 86 to be downloaded). Requested media 86 comprises at least a portion of the stored media 88. In contrast to the embodiment of FIG. 2, the media content flows through group manager portal 14 to get to the group member device of group member devices 20-30 that is requesting the shared media 16. Generally, group manager portal 14 receives content request message 52 and, upon determining that the group member device of group member devices 20-30 that is attempting to access the shared media 16 is part of an authorized group for shared media 16, transmits or allows the requested media to be downloaded from it. The media is obtained by group manager portal 14 from media source 18 either prior to receiving or in response to receiving the content request message 52.

If the embodiment of FIG. 3 reflects operation for other services, the content request message and the requested media may be replaced by requests and content that corresponds to the service request including, for example, streaming audio and/or video, or data. Such streaming audio, video and data would flow through the group manager portal prior to being delivered to the requesting group member device.

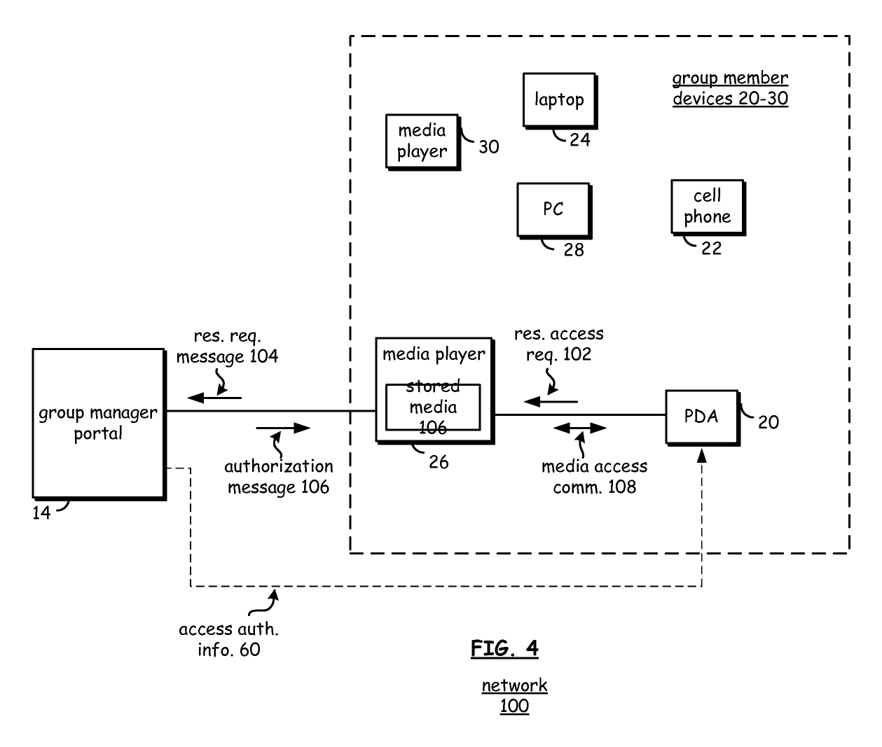

FIG. 4 is a functional block diagram that illustrates operation for accessing shared media according to a second embodiment of the invention in which shared media stored on one group member device is accessed by another group member device. Network 100 includes group manager portal 14 and group member devices 20-30 as described before. In the described embodiment of FIG. 4, however, when a group member device of group member devices 20-30 requests media content or shared media 16 stored on another group member device of group member devices 20-30, group manager portal 14 authorizes the group member device to access the shared media 16 stored on the other group member device. Alternately, a group member device may request access to resources (hardware, software, logic, account information or other data, for example). One purpose of requesting access to such resources may be to be able to access and retrieve shared media 16 either from a media server or even to access and retrieve media 16 that has been previously downloaded by the device whose resources are being requested.

More specifically, a first group member device such as PDA 20 requests access to resources of a second group member device, such as media player 26, by transmitting resource access request message 102 to media player 26. The resource access request can be for hardware or software resources or even for access to stored media 106. Thereafter, media player 26 transmits a resource request message 104 to group manager portal 14. Group manager portal 14 transmits authorization message 106 to the second group member device (here, media player 26). Media player 26, which is the second group member device in the described embodiment, receives authorization message 106 and engages in media access communications 108 with the first group member device (here, PDA 20) to enable access to the requested resource.

As a part of engaging in media access communications network 108, media player 26 transmits requested media, if the resource request was for stored media, which transmitted media is at least a portion of stored media 106. Requested media may, alternately, be accessed and downloaded by PDA 20. In one embodiment, group manager portal 14 transmits access authorization information 60 to PDA 20 that is used by PDA 20 to retrieve or download the requested media in the media access communications 108.

In the example shown, both the media player 26 and the PDA 20 are group member devices of an associated group (e.g., group 12 of FIG. 1) and have access rights to the shared media that may be accessed by group member devices 20-30. While not shown explicitly here, it should be understood that the stored media 106 might have been previously loaded in manner consistent with that described in relation to FIGS. 2-3.

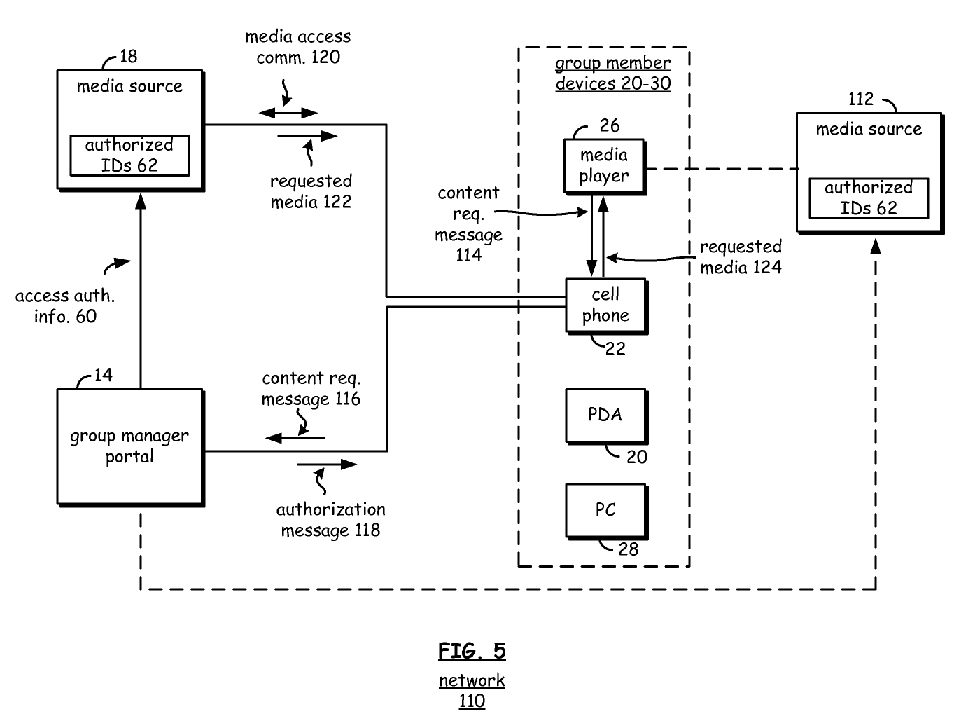

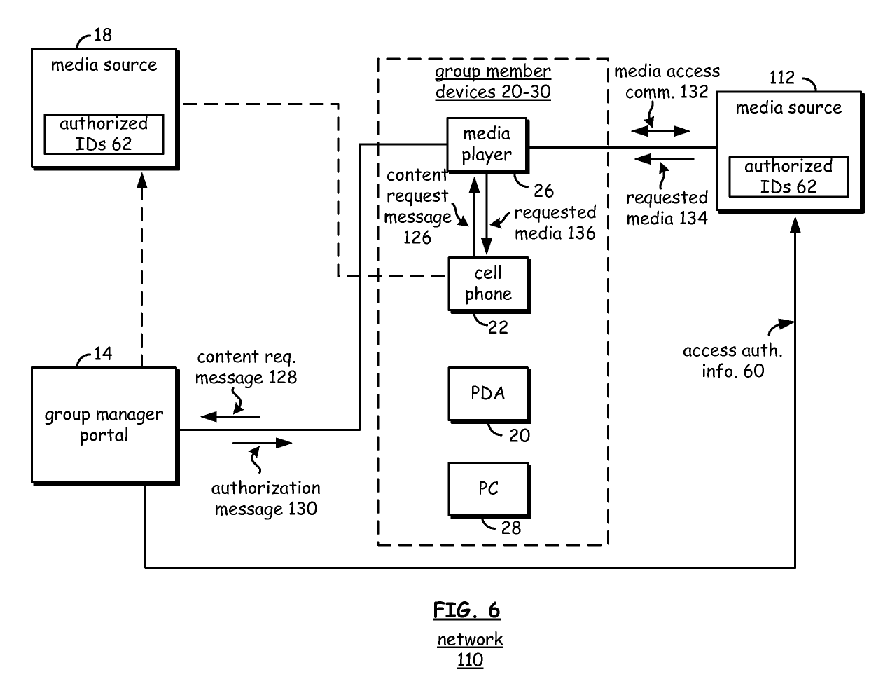

FIGS. 5 and 6 are functional block diagrams that illustrate operations for accessing shared media or other services from a plurality of media sources or service devices in which different group members are primary group members for accessing the shared media or service from corresponding media sources or service devices according to one embodiment of the invention. While the specific illustration of FIGS. 5 and 6 are directed to sharing media or services, it should be understood that a request for media content may be instead, or may also include a request for hardware or software or other resources. The example of FIGS. 5 and 6 are directed to shared media, but the concepts illustrated by the operation and description of access to shared media can apply to any shared service.

A network 110 includes media source 18 and a media source 112. In FIG. 5, cell phone 22 is a primary group member for group member devices 20-30 for shared media that is downloaded from media source 18 while media player 26 is a primary group member for media downloaded from media source 112. Accordingly, if media player 26 wants to access or download shared media from media source 18, media player 26 transmits a content request message 114 to cell phone 22 which in turn transmits content request message 116 to group manager portal 14. Content request message 114 may be, for example, a resource request message that specifically makes a request for media content and that is similar to resource access request message 102 of FIG. 4.

In response, group manager portal 14 transmits authorization message 118 to cell phone 22. Thereafter, cell phone 22 engages in media access communications 120 with media source 18 and receives or downloads requested media 122. Finally, cell phone 22 transmits or downloads requested media 124 to media player 26. As described previously, group manager portal 14 also transmits access authorization information 60 to media source 18 to enable media source 18 to validate access to media while engaging in media access communications 120.

One aspect of the embodiment of FIGS. 5 and 6 is that they illustrate that different groups may be defined for accessing different sources of media and that different group member devices may act as primary group devices for the different groups. The group membership is not necessarily the same for the multiple groups. FIGS. 5 and 6 also illustrate that any group member device can belong to multiple groups.

In the examples of FIGS. 5 and 6, the group member devices 20-30 are group members for accessing shared media from media source 18 as well media source 112 in which media player 26 is a primary group member for media downloaded from media source 112. In FIG. 6, therefore, when cell phone 22 transmits a content request message 126 to media player 26, media player 26 transmits a content request message 128 to group manager portal 14 and receives authorization message 130 from group manager portal 14. Thereafter, media player 26 engages in media access communications 132 with media source 112.

In FIG. 6, group manager portal 14 sends access authorization information 60 to media source 112 instead of media source 18. Accordingly, media source 112 validates the access to the media as a part of engaging in media access communications 132 and, in response, transmits requested media 134 to media player 26. Media player 26 then transmits or downloads requested media 136 to cell phone 22.

In FIGS. 5 and 6, cell phone 22 receives an initial content request message from media player 26 for media from media source 18 while media player 26 receives an initial content request from cell phone 22 for media from media source 112. It should be understood that, in FIG. 5, cell phone 22 could receive such an initial request for media from any group member device of group member devices 20-30. Similarly, in FIG. 6, media player 26 can receive a content request from any of the group member devices of group member devices 20-30.

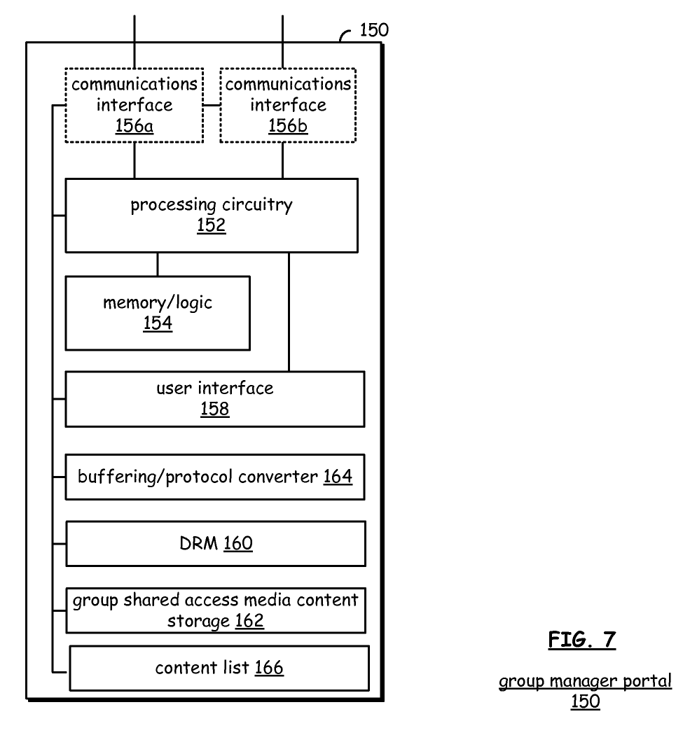

FIG. 7 is a functional block diagram of one embodiment of a group manager portal. A group manager portal 150 of FIG. 7 is similar to group manager portal 14 described before. Group manager portal 150 includes processing circuitry 152 and a memory 154 that stores computer instructions executed by processing circuitry 152 to define operational logic of group manager portal 150. The computer instructions include, for example, group operations logic to define interactions and communications with other devices to support group operations and sharing logic to support media (including media content sharing), service and resource sharing (including hardware, software, data, account and access information).

Group manager portal 150 also includes communications interfaces 156a and 156b. These communication interfaces represent any number of communications interfaces to support wired communications over local area networks and wireless communications over wireless local area networks, personal area networks, and cellular networks. They also represent interfaces for tethering and coupling to devices such as printers and hard disk drives for very specific operations. Additionally, group manager portal 150 includes a user interface 158 to generate displays and audio for a user and to receive user inputs.

Group manager portal 150 also includes digital rights management requirements 160 for group operations as described herein. The digital rights management requirements may comprise computer instructions stored within memory 154 or defined with a dedicated state logic or memory block. Accordingly, access to shared media and services can be based upon identities of devices seeking access to the shared media in relation to the digital rights management requirements specified in digital rights management requirements 160.

In one embodiment, group manager portal 150 monitors a number of times shared media is accessed by one or of the group member devices 20-30 and denies access after the shared media or service has been accessed a specified number of times either collectively by the group of wireless devices 12, by a sub-group of the group of wireless devices 12 or by any one group member device of the group member devices 20-30. Such access limitations may be based upon digital rights management requirements 160 or upon license/usage restrictions or both.

Group manager portal 150 also includes group shared access media content storage 162 for storing media content and other data that may be shared with group members of group member devices 20-30. Thus, for example, group manager portal 150 may download media from a specified media source and subsequently share the media (allow access to the media) by authorized group member devices of group member devices 20-30 when one of the group member devices requests access.

Group manager portal 150 includes a buffering and protocol converter block 164 for buffering shared media received on a first communications interface (e.g., interface 156a) until transmitted on a second communications interface (e.g., interface 156b). Buffering and protocol converter block 164 is further operable, based on capabilities of at least one group member device that is to receive the shared media, to convert a format or protocol used to deliver the media content to a format or protocol that is compatible with the capabilities of the group member device(s) that will receive the media content. For example, the received media content could include high definition video received that is to be delivered to a cell phone 22 having a limited graphics display. In this case, group manager portal 150 may decimate the media content to generate a video display that is sized and has resolution appropriate for the display capabilities of cell phone 22.

The group manager portal 150 further maintains a content list that includes a list of content stored on each group member device of the group member devices 20-30. This content list 164 is populated with entries that result from authorizing access to shared media 16, from transmitting shared media 16 to a group member device, or by communicating with one or more group member devices 20-30 to determine what shared media 16 is stored thereon.

In one embodiment, group manager portal 150 transmits the content list 164 or at least a portion of content list 164 to at least one group member device of the group member devices 20-30. Thus, group manager portal 150 is operable to receive a content request message originated by a first group member device for shared media previously delivered to a second group member device. When such a content request message is received, group manager portal 150 authorizes the first group member device to access to the shared media that was previously delivered to the second group member device, the group manager portal transmits access information to at least one of the first and second group member devices to enable the first group member device to access shared media stored on the second group member device. Alternately, group manager portal 14 transmits the shared media to the first group member device. To transmit the shared media 16 to the first group member device, group manager portal 14 retrieves the shared media from media source 18 or from the second group member device.

In an alternate embodiment, group manager portal 150 determines a required format or protocol for the shared media or other content including data or streaming media received from a network service provider for the first group member device based upon device capabilities of the first group member device, formats the shared media or content to correspond with the required format or protocol and transmits the shared media or content in the required format or protocol to the first group member device of group member devices 20-30.

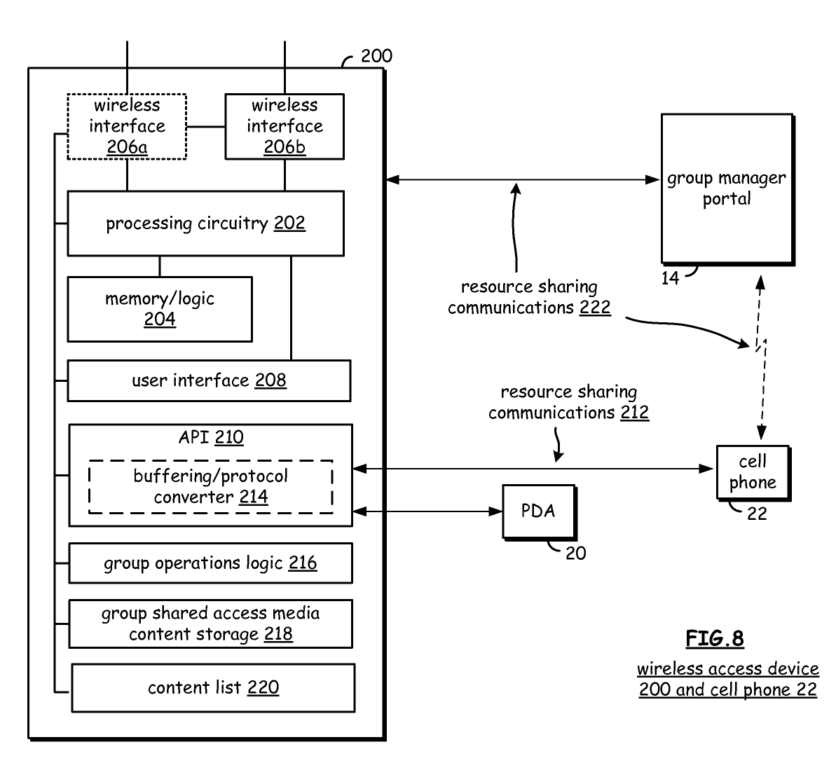

FIG. 8 is a functional block diagram of a group member device according to one embodiment of the invention. A wireless access device 200 includes processing circuitry 202 and a memory 204 that stores computer instructions executed by processing circuitry 202 to define operational logic of wireless access device 200. The computer instructions include, for example, group operations logic to define interactions and communications with other devices to support group operations related to sharing of services and/or resources. Wireless access device 200 also includes communications interfaces 206a and 206b. It should be understood that these communication interfaces represent any number of communications interfaces to support communications over local area networks, wireless local area networks, personal area networks, cellular networks and also tethering and coupling to devices such as printers and hard disk drives for very specific operations. Additionally, wireless access device 200 includes a user interface 208 to generate displays and audio for a user and to receive user inputs from the user.

Wireless access device 200 also includes an application programming interface block (API) 210 that defines an interface and associated logic to support for group operations as described herein. Generally, API 210 includes logic and a communications interface that support group member communications for sharing media, services and resources. Such an interface includes, for example, communicating with defined signals to request access to shared media, for requesting shared media from another group member, for uploading shared media for delivery to another group member, and for storing access related data. The interface also can include using defined signals for communicating with at least one of group manager portal 14/150, a media source or other group member to establish access rights to share media, other services, or resources.

API 210 also includes logic to facilitate hardware and other resource sharing between group member devices or associated devices. Thus, resource sharing logic specifically includes interfaces and signaling logic that enable other group member devices to utilize resources within wireless access device 200. For example, another device could access specific memory areas (e.g., content storage area 216), or specific hardware resources such as software and hardware based communication interfaces. In one embodiment, a cell phone such as cell phone 22 may engage in resource sharing communications 212 to gain access to resources of wireless access device 200. Alternately, or additionally, cell phone 22 may engage in any sharing related communications to request sharing of media or services.

The resource sharing communications 212 include a request by cell phone 22 to access resources of wireless access device 200. The resources can include hardware as well as software, data, access logic, or media content. If a wireless access device 200 has software and hardware required to access a specified account for media, for example, the request by cell phone 22 can includes a request to utilize such software and hardware to download media using an associated account.

As another example, a PDA such as PDA 20 with only wireless local area network or personal area network (e.g., Bluetooth™) protocol radio transceiver elements may utilize cellular radio transceiver elements of wireless access device 200 to communicate over a cellular network to establish a communication link with a media source to download desired media or other service provider to access a desired service. Generally, resource sharing may be unlimited or may be limited according to access type, resource being accessed, a specified number of successful accesses, or by time. In one embodiment, wireless access device 200 includes internal logic for determining resource sharing permissions and resource access that may be given to another device such as the PDA or cell phone 22.

In the exemplary embodiment of FIG. 8, wireless access device 200 communicates with a remote device such as group manager portal 14 by engaging in sharing related communications such as resource sharing communications 222 to determine sharing permissions and access that may be given to another device. Alternatively, cell phone 22 may communicate with group manager portal 14 in resource sharing communications 222 to determine access permissions for accessing resources of wireless access device 200. Resource sharing communications 212 and 222 may be by a direct wired or tethered connection or by a wireless communication using any known wireless communication protocol and can specifically include communications over a plurality of packet data networks and cellular and other telephone networks.

In an embodiment in which group manager portal 14 or another device makes such resource sharing determinations, such logic may be a part of the logic that makes media access and service sharing determinations. Thus, for a particular group, the group manager portal 14 determines what media or services may be shared, what resources may be shared, and/or any limitations by resource, media, service, time or count. It should also be noted that the group access logic for making such determinations may define groups that are temporary or that have long lasting or permanent associations with each other until such associations are modified.

API 210 includes computer instructions to enable wireless access device 200 to engage in resource sharing communications 212 with cell phone 22 and other devices to establish resource sharing which is allowed according to resource sharing logic stored within or specified by a remote device such as group manager portal 14. The resource sharing communications 214 include receiving a request to share a hardware resource from another group member, transmitting display information to the other group member that define hardware resource sharing options, receiving a response from the other group member, and operating according to commands received from the other group member. The display information that wireless access device 200 is operable to transmit includes any one of a graphical user interface type of transmission or even text characters that correspond to the resource sharing options.

Optionally, API 210 includes a buffering/protocol converter 214 that is similar in operation and logic to buffering/protocol converter 164 of FIG. 7. The buffering and protocol converter block 214 is operable to buffer shared media, content, or data received on a first communications interface (e.g., interface 206a) until transmitted on a second communications interface (e.g., interface 206b). Buffering and protocol converter block 214 is further operable to, based on capabilities of at least one group member device that is to receive the shared media, convert a format or protocol used to deliver the media content to a format or protocol that is compatible with the capabilities of the group member device(s) that will receive the media content.

For example, if the media content audio files received over the first communication interface 206a is in a first format, but is required to be delivered in a second format, 200 may convert the media content to the appropriate protocol. To illustrate, if wireless access device 200 is an iTunes™_{capable} device that communicates with a media source that delivers audio files in an AAC format, but the requesting group member device requires MP3 format audio files, block 214 is operable to buffer, if necessary, and to convert the audio files to MP3 format prior to transmitting the shared media to the group member device requesting the shared media content.

Wireless access device 200 further includes group operations logic 216 that defines group operations according to the various embodiments for accessing and sharing shared media based on a group association. Group operations logic 216 not only defines logic for group related access of group member devices as disclosed herein, but also could define logic for hardware resource sharing between group members. For example, group operations logic 216 could include resource sharing access logic that evaluates group associations to determine whether resource sharing is permitted with the other device requesting resource sharing. Such evaluation occurs prior to API 210 engaging in resource sharing communications 212 so that only group members are allowed to share hardware resources.

Additionally, a group shared access content storage 218 for storing shared media that may be accessed by group member devices is included. Finally, wireless access device 200 includes a content list 220 for tracking content on each of the group member devices. Content list 220 is included in at least one embodiment in which the wireless access device is a primary group member having account access and control rights as discussed previously in relation to cell phone 22.

FIG. 9 illustrates a method for creating and managing group access to shared media that includes associating a plurality of group member devices to a group (250) and

storing access permissions for accessing shared media for at least one the plurality of group member devices (252). The stored access permissions define access permissions for the group member devices for sharing at least one of services, media or device resources. The method further includes, in one embodiment, identifying shared media stored upon the group member devices (254). The step of identifying the shared media comprises at least one of communicating with group member devices to determine what shared media content is stored on the group member devices (that may be shared with other group member devices) and maintaining a list of shared media content that is transmitted to or downloaded by the group member devices. Based on stored digital rights management requirements for group access to shared media, the method further includes authorizing access to the shared media by at least one of the group member devices (256) and communicating with at least one group member device to facilitate access to the shared media (258) or to a service or resource.

The step of communicating with at least one group member device to facilitate access to the shared media, service or resource may include receiving and forwarding the shared media to one of the plurality of group member devices (260) when media is being shared. This step optionally includes receiving the shared media from a shared media source (262) or uploading the shared media from a group member (264). For example, if a first group member requests the shared media, the method includes uploading the shared media from a second group member for delivery to the first group member.

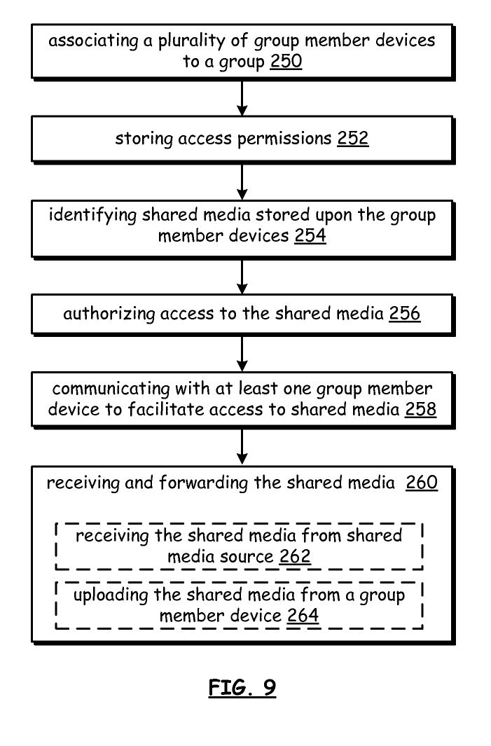

FIG. 10 is a flowchart that illustrates a method for delivering media content to one group member device through another according to one embodiment of the invention. The method includes a group manager portal 14 receiving a content request message from a first group member device for shared media for second group member device (270) and determining the second group member device is authorized to access the shared media (272). Thereafter, the method includes transmitting an access authorization (274) to enable either one of the first and second group member devices to access or download shared media from a media source or from another group member device for the second group member device. The method can include, for example, authorizing the first group member device to access and subsequently deliver the shared media to the second group member device (276). An alternate method includes, instead of step 276, delivering the shared media to the first group member device (278) to enable the first group member device to deliver the shared media to the second group member device.

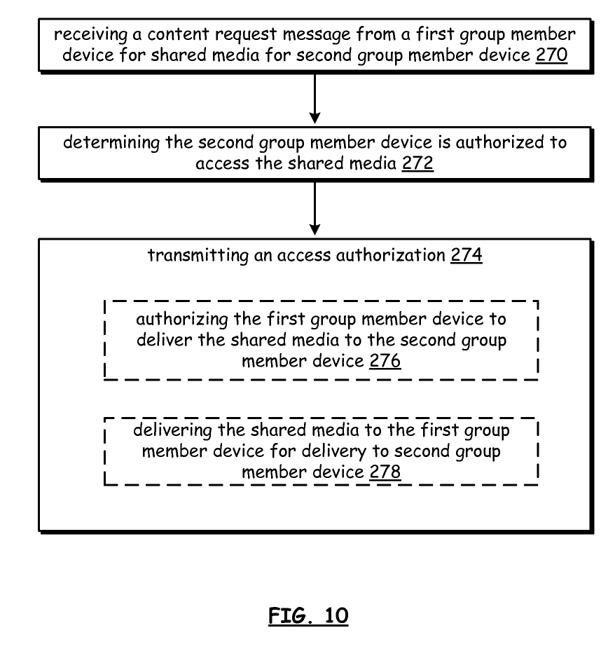

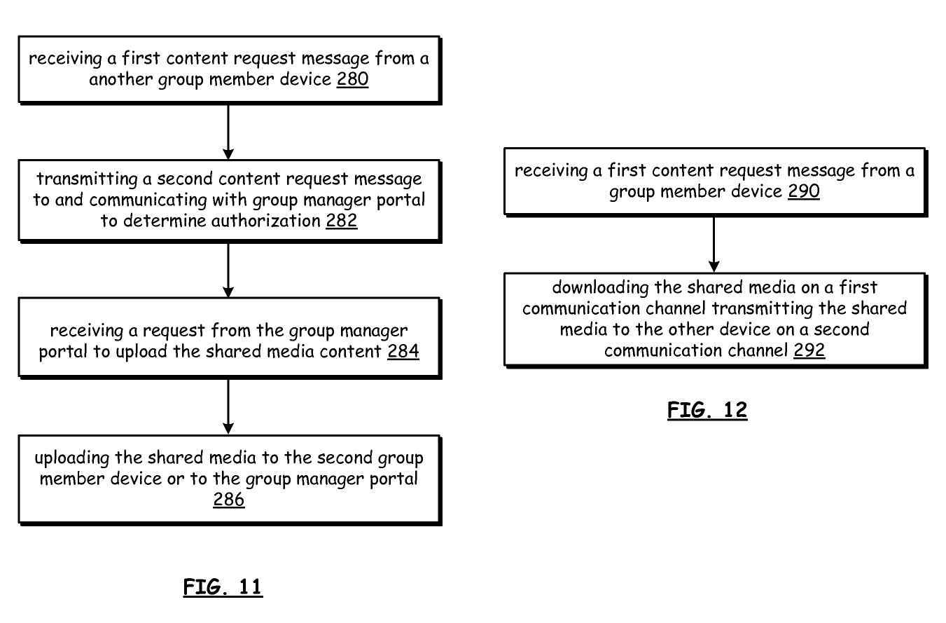

FIG. 11 illustrates a method by a handheld first group member device operable to access shared media based on a group association that includes a plurality of group member devices according to one embodiment of the invention. The method includes receiving a first content request message from another group member device (280) and transmitting a second content request message to a group manager portal to determine that the second group member device is authorized to access the shared media (282). This step can include additional steps of and communicating with the group manager portal to determine authorization. Thereafter, the method includes receiving a request from the group manager portal to upload the shared media content (284) and then uploading the shared media to the other group member device or to the group manager portal (286).

The handheld group member device receive a request from the group manager portal to upload the shared media content to the group manager portal for delivery to the second group member device in step 284 thus requiring the media to be uploaded to the group manager portal. Alternately, the handheld group member device may receive a request from the group manager portal to upload the shared media content directly to the other group member device in step 284 in which case the handheld group member uploads (transmits) the shared media to the other group member device.

FIG. 12 illustrates a method by a handheld group member device operable to deliver shared media based on a group association that includes a plurality of group member devices according to one embodiment of the invention. The method includes receiving a first content request message from another group member device (290) and transmitting a second content request message to a group manager portal. Thereafter, the method includes downloading the requested shared media on a first communication channel from the group manager portal or a media source and transmitting the shared media to the second device on a second communication channel (292). It should be noted that the “other media source” could include another group member device.

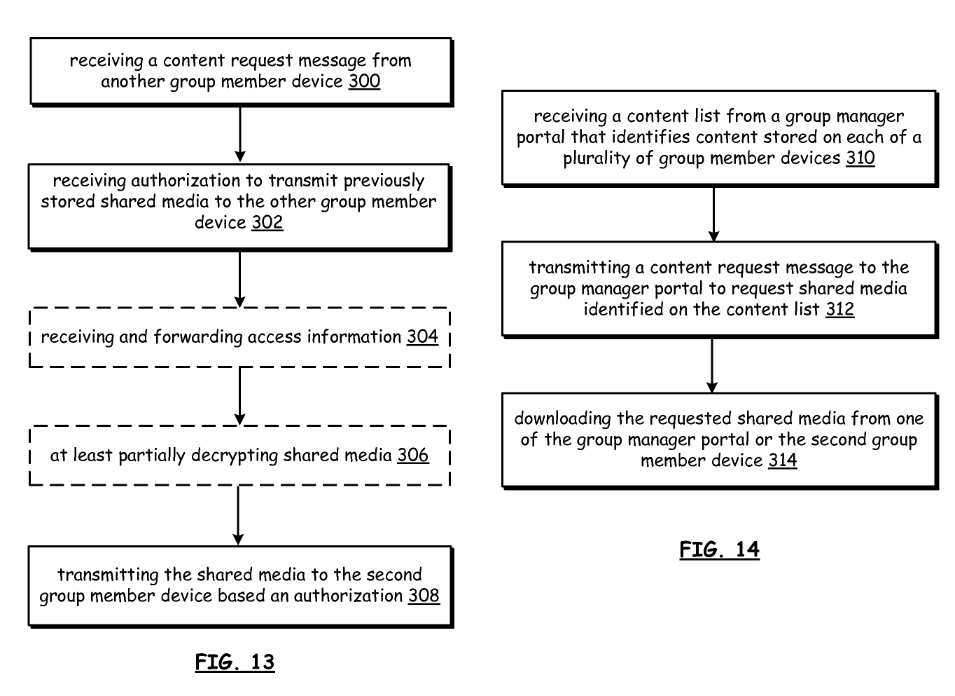

FIG. 13 illustrates a method by a group member device operable to deliver shared media based on a group association that includes a plurality of group member devices according to an alternate embodiment of the invention. The method includes receiving a first content request message from another group member device (300) and transmitting a second content request message to a group manager portal. Thereafter, the method includes receiving authorization from the group manager portal to transmit previously stored shared media to the other group member device (302).

After receiving authorization, the method can include, optionally, receiving and forwarding access information to the second group member device (304). The access information may include either an authorization code or number or an encryption key for decrypting all or at least a portion of the shared media content. Alternately, the method can include at least partially decrypting the shared media (306). Finally, the method includes transmitting the shared media to the other group member device based an authorization received from the group manager portal (308). In this embodiment, the handheld group member device performing the method steps of FIG. 13 had previously received and stored the shared media and is therefore sharing the stored media upon receiving authorization from the group manager portal.

FIG. 14 illustrates a method by a group member device for accessing shared media based on a group association that includes a plurality of group member devices according to an embodiment of the invention. The method includes receiving a content list from a group manager portal that identifies content stored on each of a plurality of group member devices (310) and transmitting a content request message to the group manager portal to request shared media identified on the content list (312). Thereafter, the method includes downloading the requested shared media from one of the group manager portal or the second group member device (314). It should be understood that additional communications to allow the group manager portal and/or media server to validate the access to the shared media based on a group association could be included herein. The specific nature of such communications may be any of the described embodiments of such messaging and logic described above.

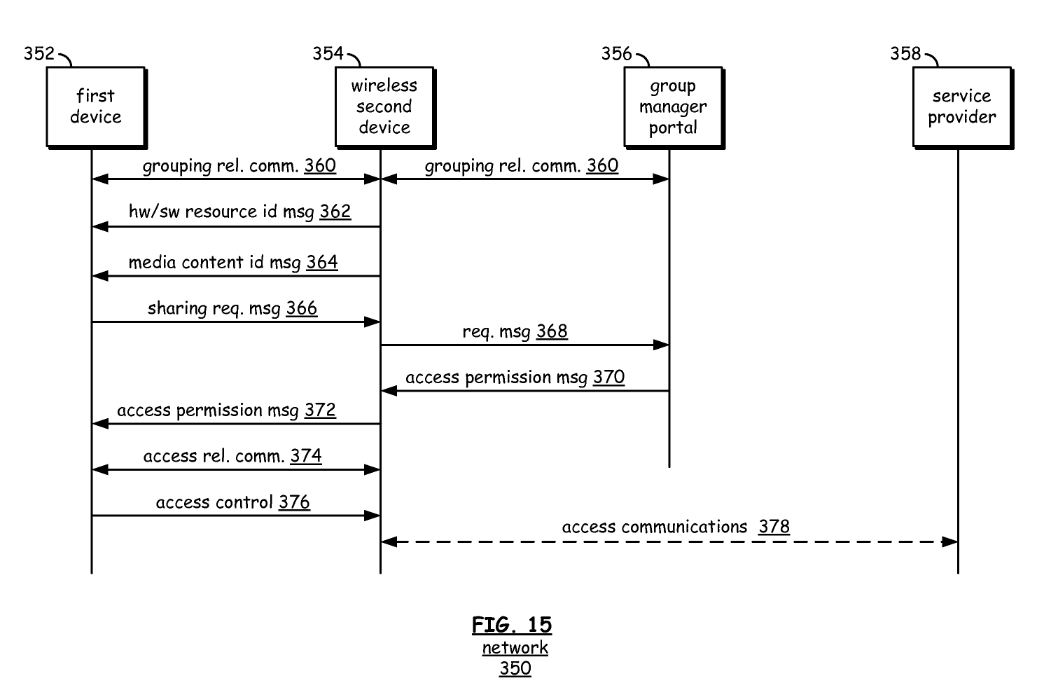

FIG. 15 is a signal sequence diagram that illustrates operation for resource sharing according to one embodiment of the invention. A network 350 includes a first device 352, a wireless second device 354, a group manager portal 356 and a service provider 358 that are operably disposed to communicate through wired or wireless communication paths and/or networks.

First device 352 typically is a wireless communication device but is also capable of communicating through a wired connection such as a so called tether. First device 352 may be one that is not a wireless capable device that can only communicate through wired connections. Wireless second device 354 is capable of supporting both wired and wireless communications by way of short distance wireless communications (e.g., personal area network communications), longer distance wireless communications (e.g., wireless local area networks, cellular networks, satellite networks), and wired communications over the various known wired and wireless networks. Group manager portal 356 service provider 358 is similar to group manager portals that were previously described. Service provider 358 can be any type of network service provider including but not limited to media servers that provide media related services. Other exemplary service include data services, device testing, maintenance and repair services, scheduling services, etc.

Portal 356 engages in grouping related communications 360 with at least one of devices 352 and 354 to establish a group or association between the two devices. Thereafter, wireless second device 354 sends at least one of a hardware and/or software resource identification message 362 and a media content identification message 364 to device 352. Messages 362 and 364 identify content, services and/or resources that device 352 may access. For example, the resources can include processing resources, communication resources, data storage resources, video processing resources, account management related resources, etc. The account management related resources can include software and/or stored account access information, logic, data and protocols.

Thereafter, first device 352 transmits a resource request message 366 to wireless second device 354. Wireless second device 354 then transmits a sharing request message 368 to portal 356 to determine if first device 352 is allowed to access or share services, media or resources as identified in sharing request message 366. If media or other content is identified in message 366, such media or content may be stored within wireless second device 354 or in another group member device. The sharing request may also be for a hardware or software resource of wireless second device 354 or a request to access streaming media or to request to a service (e.g., a shared service). Portal 356 transmits, in response to receiving sharing request message 368, an access permission message 370 to wireless second device 354 granting or denying access. The access that is granted may be limited in any manner including a number of access times, a duration that access is allowed, or a definition or identification of which resources may be accessed wherein the identification of allowed access may be less than that which was requested in message 366.

Wireless second device 354 then sends access permission message 372 to first device 352 that corresponds to message 370. Thereafter, as appropriate according to the type of access being requested, wireless second device 354 engages in access related communications 374 with first device 352 to support the access. These communications can include wireless second device 354 generating display signals or options for first device 352 to allow a user of first device 352 to generate selected responses. If, for example, first device 352 has limited graphing capabilities, wireless second device 354 may generate display signals to prompt first device 352 to generate corresponding displays. Thus, first device 352 then generates resource access/control signals 376 that correspond to the allowed access. If such access includes, for example, using hardware or software resources of wireless second device 354 to communicate with a service provider 358, wireless second device 354 engages in access communications 378 with service provider 358 to support the permitted or authorized access using the hardware of software resources of wireless second device 354.

In one embodiment, wireless second device 354 includes cellular communication hardware and software which is used to support communications 378 according to access control signals 370. In another embodiment, wireless second device 354 includes application and account related software and data that is required to establish access communications 378. Accordingly, first device 352 uses such application and accounted related software and data to communicate with and access the services of service provider 358.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Moreover, the term “operable to” requires a device to include logic, circuitry, or computer instructions stored in memory or other structure that facilitates the functionality associated with such language. As one of ordinary skill in the art will also appreciate, inferred coupling (i.e., where one element is coupled to another element by inference) includes direct and indirect coupling between two elements in the same manner as “operably coupled”.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A group management system associated with a telephone network infrastructure, the group management system supporting at least one user and a plurality of communication devices, at least one of the plurality of communication devices comprising telephone circuitry, the telephone network infrastructure comprising a data network, each of the plurality of communication devices having at least one resource, the group management system comprising:
at least one host computer coupled to the data network;
portal software that is executed by the at least one host computer;
the at least one host computer attempts to identify a group of related communication devices from the plurality of communication devices based on information related to the at least one user;
the portal software, via the data network, assists in identifying the group of communication devices to the at least one user;
the at least one host computer responds to a first instruction and a second instruction received via the data network from the at least one user, the first instruction relating to sharing at least one of a media, service or resource with one of the group of communication devices;
the at least one host computer, in response to the second instruction, adds another of the plurality of communication devices to the group of communication devices; and
the at least one host computer responds to the first instruction by enabling the sharing of the media, service or resource via the data network.

2. The group management system of claim 1, wherein the host computer is further operable to receive and to deliver the media content to another of the plurality of communication devices.

3. The group management system of claim 1, wherein the host computer is further operable to:
download shared media on a first communication channel from another of the plurality of communication devices, or a media source; and
transmit the shared media on a second communication channel to respond to the first instruction.

4. The group management system of claim 1, wherein the host computer is further operable to:
receive a resource request in the first instruction for one group member device to share wireless transceiver circuitry with a second group member device; and
transmit one of a message or signal to allow the wireless transceiver circuitry to be shared.

5. A group manager portal for managing a group of wireless devices, the group manager portal comprising:
a communications interface operable to communicate with each of the group of wireless devices via at least one of a wired and a wireless network;
memory that includes a portal operations program; and
processing circuitry coupled to the communications interface and the memory, wherein the processing circuitry, in combination with the communications interface and memory, is operable to:
associate each group member device of the group of wireless devices to establish group membership for the group of wireless devices; and
communicate with at least some of the group member devices of the group of wireless devices to support at least one of service sharing, resource sharing and media sharing wherein media sharing comprises at least one of sharing stored media and sharing streaming media.

6. The group manager portal of claim 5 wherein,
upon receiving a request transmitted by a first group member device of the group of wireless devices to access media stored on another group member device, the group manager portal is operable to:
validate the request to access media; and
upon a successful validation, notify at least the first group member device making the request to facilitate the access.

7. The group manager portal of claim 5, the processing circuitry in combination with the communications interface, further operable to:
define digital rights management requirements that allow access to shared media by the group member devices of the group of wireless devices; and
facilitate access to the shared media by the group of wireless devices to enact the digital rights management requirements.

8. The group manager portal of claim 5, wherein:
the group manager portal communicates with at least some of the group member devices of the group of wireless devices to support media sharing to identify shared media stored thereupon;
the processing circuitry of the group manager portal is further operable to maintain a content list of shared media content stored in each group member device of the group of wireless devices; and
the processing circuitry of the group manager portal is further operable to transmit the content list to at least one group member device.

9. The group manager portal of claim 5, the processing circuitry, in combination with the communications interface, is further operable to:
receive a content request message originated by a first group member device for shared media;
authorize the first group member device to access to the shared media; and
transmit access information to at least one of the first and second group member devices to enable the first group member device to access shared media.

10. The group manager portal of claim 5, the processing circuitry, in combination with the communications interface, is further operable to:
receive a content request message originated by a first group member device for shared media stored on another group member device; and
transmit either access information or the shared media to the first group member device.

11. The group manager portal of claim 10, the processing circuitry, in combination with the communications interface, is further operable to retrieve the shared media from one of a media source or a second group member device to transmit the shared media to the first group member device.

12. The group manager portal of claim 5, the processing circuitry further operable to store access permissions for each group member device, wherein the stored access permissions are different for at least two of the group member devices.

13. The group manager portal of claim 5, the processing circuitry further operable to store access permissions in the memory for sub-groups of group member devices, wherein the stored access permissions are different for the group member devices of different sub-groups.

14. The group manager portal of claim 5, the processing circuitry further operable to:
monitor a number of times shared media or service is accessed by one or more group member devices; and
deny access after the shared media or service has been accessed a specified number of times the one or more group member devices.

15. The group manager portal of claim 5, the processing circuitry further operable to maintain at least one billing record for particular shared media transfers and access to particular services.

16. The group manager portal of claim 5, the processing circuitry further operable to:
maintain at least one billing record that is associated with a cell phone account for at least one shared media transfer or access to a service; and
wherein a cell phone associated with the cell phone account is a primary group member device that has account access rights to modify data and control parameters associated with the group of wireless devices.

17. The group manager portal of claim 5, the processing circuitry, in combination with the communications interface, is further operable to:
buffer shared media that is received from the media source; and
transmit the buffered shared media to the group member device.

18. The group manager portal of claim 5, the processing circuitry, in combination with the communications interface, is further operable to:
determine a required format or protocol for the shared media for the group member device based upon device capabilities of the group member device;
format the shared media to correspond with the required format or protocol; and
transmit the shared media in the required format or protocol to the group member device.

19. The group manager portal of claim 5, the processing circuitry, in combination with the communications interface, is further operable to:
transmit access information including an encryption key to the group member device; or
at least partially decrypt the shared media content prior to allowing access to the shared media content by the group member device.

20. A method for creating and managing group access to services, resources and shared media, comprising:
associating a plurality of group member devices to a group;
receiving an access request for sharing at least one of the services, resources, and media including stored and streaming media for at least one the plurality of group member devices; and
responding to the access request by transmitting at least one of an approval indication, access information or a signal that corresponds with the requested access.

21. The method of claim 20, further comprising receiving an access request for a first group member device to share transceiver circuitry with a second device and validating the access request.

22. The method of claim shared media 20, further comprising:
storing access permissions for sharing media or services for at least one the plurality of group member devices;
identifying shared media stored upon the group member devices; and
receiving and forwarding the shared media to one of the plurality of group member devices.

23. The method of claim 22, further comprising:
receiving a content request message from a first group member device for the shared media that is to be delivered to a second group member device;
determining that the second group member device is authorized to receive the shared media; and
authorizing the first group member device to deliver the shared media to the second group member device.

24. The method of claim 22, further comprising:
receiving a content request message originated by a first group member device for shared media previously delivered to a second group member device; and
authorizing the first group member device to access the shared media that was previously delivered to the second group member device.

25. The method of claim 22, further comprising:
receiving a content request message originated by a first group member device for shared media previously delivered to a second group member device;
uploading the shared media from the second group member device; and
delivering the shared media to the first group member device.

26. A method for operation of a group member device operable to access shared media based on a group association that includes a plurality of group member devices, comprising:
receiving a first access request message from another group member device;
transmitting a second access request message to a group manager portal;
communicating with the group manager portal and determining to support the requested access by the other group member device; and
transmitting one of shared media or access information to support the requested access.

27. The method of claim 26, further comprising:
receiving a request from the group manager portal to upload shared media content to the group manager portal for delivery to the other group member device.

28. The method of claim 26, further comprising:
receiving the shared media on a first communication channel from one of the group manager portal or a media source; and
transmitting the shared media to the other group member device on a second communication channel.

29. The method of claim 26, further comprising transmitting the shared media to the other group member device based an authorization received from the group manager portal, wherein the group member device previously received and stored the shared media.

30. The method of claim 26, further comprising at least one of:
receiving access information from the group manager portal and forwarding the access information to the other group member device; and
decrypting at least a portion of shared media prior to transmitting the shared media to the other group member device.

31. The method of claim 26, further comprising:
receiving a content list from the group manager portal that identifies content stored on each of the plurality of group member devices;
transmitting a content request message to the group manager portal to request shared media identified on the content list; and
downloading the requested shared media from one of the group manager portal or a group member device.
